(19) United States
(12) Patent Application Publication
(10) Pub. No.: US 2007/0270192 A1
(43) Pub. Date: Nov. 22, 2007

(54) PORTABLE COMMUNICATION DEVICE AND METHOD FOR CONSERVING POWER

(75) Inventors: Han-Che Wang, Shenzhen City (CN); Hsin-Nan Hu, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/750,344

(22) Filed: May 18, 2007

(30) Foreign Application Priority Data
May 19, 2006 (CN) 200610060721.7

(51) Int. Cl. H04B 1/38

(52) U.S. Cl. 455/574

(57) ABSTRACT

An exemplary method for conserving power of a portable communication device includes: supplying voltage by a power supply; distributing voltages to other units of the portable communication device including a communication unit and a backlight unit; the portable communication device entering a normal mode after being powered by one of the voltages; generating digital voltage signals corresponding to the voltage supplied by the power supply; detecting a voltage of the digital voltage signals to obtain a detected voltage; comparing the detected voltage with a predetermined value; and if the detected voltage is equal to or less than the predetermined value, changing from the normal mode to a power conserving mode, and stopping distribution of the voltages to at least one of the communication unit and the backlight unit. Thereby, an operational time of other units of the portable communication device can be prolonged.

### CROSS REFERENCE TO RELATED APPLICATION

This application is related to a commonly-assigned pending application filed concurrently herewith and also entitled “PORTABLE COMMUNICATION DEVICE AND METHOD FOR CONSERVING POWER”. Disclosure of the above identified application is incorporated herein by reference.

### BACKGROUND OF THE INVENTION

1. Field of the Invention

The present invention relates to portable communication devices and methods for conserving power of portable communication devices, and especially to a portable communication device and a method involving disabling of a unit of the portable communication device and thereby prolonging an operational time of other units of the portable communication device.

2. Description of Related Art

In the so-called “information age”, portable communication devices have become more and more important in people's lives. Portable communication devices include mobile phones, personal digital assistants (PDAs), and other similar devices.

A typical portable communication device is supplied with voltage by a battery. Because the capacity of the battery is limited, when the voltage of the battery is below a certain value, the portable communication device becomes unusable.

A common type of personal digital assistant (PDA) available in the market includes a communication unit. The communication unit can be disabled by a user independently of other functional units of the PDA. Thus, an operational time of the other functional units of the PDA can be prolonged. In detail, the PDA has a so-called flight mode. If the user selects the flight mode, the PDA restarts and disables the communication unit. After the communication unit of the PDA is disabled, the PDA can still be used to perform other functions, such as searching desired contact information in an address list, playing games, and so on. However, the communication unit needs to be disabled manually. The user may disable the communication unit only after the voltage of the battery has dropped below a certain critical threshold value.

Therefore, a heretofore unaddressed need exists in the industry to overcome the aforementioned deficiencies and inadequacies.

### SUMMARY OF THE INVENTION

A portable communication device and a method for conserving power of a portable communication device are provided. The portable communication device can automatically stop supplying voltage to a communication unit thereof, when the voltage of the portable communication device is equal to or less than a predetermined value, thereby prolonging an operational time of the portable communication device.

The portable communication device includes a power supply, a power management unit, an analog-to-digital converter and a central processing unit. The power supply supplies voltage to the power management unit and the analog-to-digital converter. The power management unit distributes one or more corresponding voltages to other units of the portable communication device. The analog-to-digital converter generates digital voltage signals corresponding to the voltage supplied by the power supply. The central processing unit includes a controlling module and a detection module. The controlling module signals the portable communication device to enter a normal mode after being powered by a voltage of the central processing unit. The detection module receives the digital voltage signals from the analog-to-digital converter, detects a voltage of the digital voltage signals to obtain a detected voltage, and compares the detected voltage with a predetermined value. If the detected voltage is equal to or less than the predetermined value and a current mode of the portable communication device is the normal mode, the controlling module signal the portable communication device to change from the normal mode to a power conserving mode, and when the portable communication device changes from the normal mode to the power conserving mode, the controlling module signals the power management unit to stop distributing voltage to at least one of the other units of the portable communication device selected from the group consisting of a communication unit and a backlight unit.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a front view of a mobile phone in accordance with an exemplary embodiment of the present invention.

FIG. 2 is a block diagram of hardware infrastructure of the mobile phone of FIG. 1.

FIG. 3 is a flowchart of an exemplary method for conserving power of the mobile phone of FIG. 1.

### DETAILED DESCRIPTION OF THE INVENTION

The present features and functions involving conserving power can be incorporated in a portable communication device such as a mobile phone or a personal digital assistant (PDA). The following detailed description of exemplary and preferred embodiments is made with reference to the attached drawings.

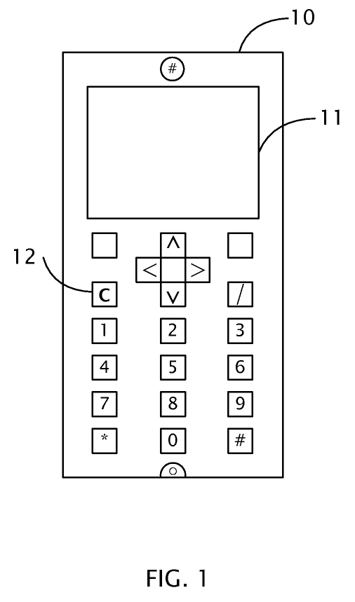

FIG. 1 is a front view of a mobile phone 10 in accordance with an exemplary embodiment of the present invention. The mobile phone 10 includes a display panel 11 and a keypad 12. The display panel 11 is configured for displaying information of the mobile phone 10, such as incoming calls, text messages, an address list, and so on. The keypad 12 includes a plurality of function keys and alphanumeric keys for users to enter operational instructions or other information.

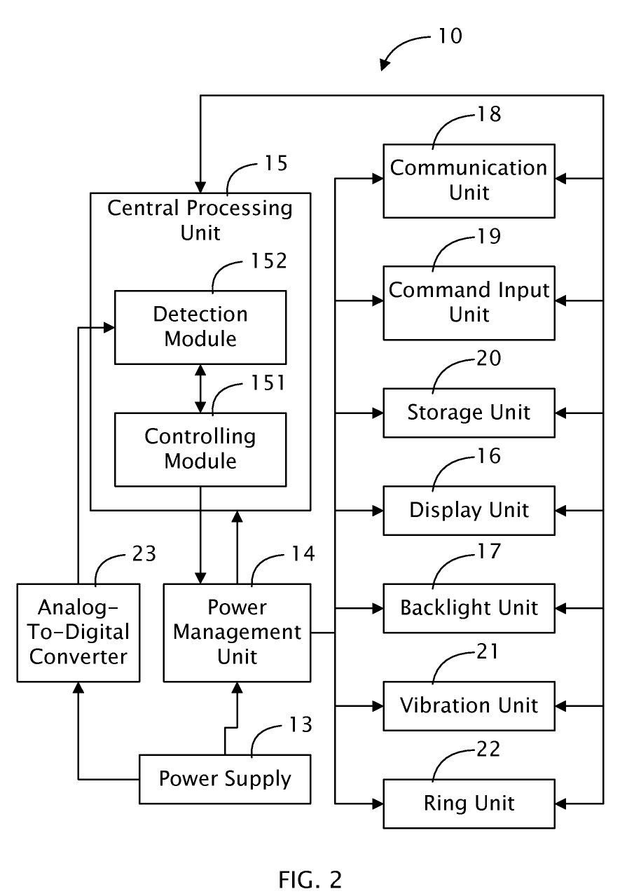

FIG. 2 is a block diagram of hardware infrastructure of the mobile phone 10. In this aspect, the mobile phone 10 includes a power supply 13, a power management unit 14, a central processing unit 15, a display unit 16, a backlight unit 17, a communication unit 18, a command input unit 19, a storage unit 20, a vibration unit 21, and a ring unit 22.

The power supply 13 may be a nickel-cadmium battery, a lithium-ion battery, or another suitable kind of secondary cell. The power supply 13 supplies voltage to the power management unit 14. The power management unit 14 receives the voltage from the power supply 13, and distributes corresponding voltages to various units of the mobile phone 10. The units include the central processing unit 15, the display unit 16, the backlight unit 17, the communication unit 18, the command input unit 19, the storage unit 20, the vibration unit 21, and the ring unit 22.

The display unit 16 is configured for displaying information of the mobile phone 10 via the display panel 11. The information may include incoming calls, text messages, an address list, and so on. The backlight unit 17 is configured for illuminating the display panel 11. After the operational instructions are input on the command input unit 19 by the user, the command input unit 19 can process the operational instructions accordingly. In particular, the command input unit 19 is configured for generating corresponding command instructions, and sends the command instructions to the central processing unit 15.

The communication unit 18 is configured for performing communication functions of the mobile phone 10. That is, the communication unit 18 receives and/or transmits communication signals via wireless communication means, and as a result the mobile phone 10 is able to communicate with other communication devices (not shown).

After the mobile phone 10 receives an incoming call or a text message, the central processing unit 15 signals the vibration unit 21 and/or the ring unit 22 to vibrate and/or ring, so as to alert the user.

The storage unit 20 stores the address list, the text messages, and so on. Modes of the mobile phone 10 include a normal mode and a power conserving mode. In the normal mode, the mobile phone 10 can perform all its normal functions. The normal functions include receiving incoming calls, dialing outgoing telephone number, searching contact information, voice dialing or voice alerting, and so on. In the power conserving mode, the central processing unit 15 signals the power management unit 14 to stop distributing voltage to the communication unit 18 and/or the backlight unit 17. Thereby, the mobile phone 10 cannot perform the function of receiving incoming calls or dialing the outgoing telephone number, and/or cannot perform the function of the display unit 16 being illuminated by the backlight unit 17.

The mobile phone 10 further includes an analog-to-digital converter 23. After the mobile phone 10 is powered on, the power supply 13 supplies voltage to the analog-to-digital converter 23. The analog-to-digital converter 23 generates digital voltage signals corresponding to the voltage, and sends the digital voltage signals to the central processing unit 15.

The central processing unit 15 includes a controlling module 151 and a detection module 152. The controlling module 151 signals the mobile phone 10 to enter the normal mode after being powered by a voltage of the central processing unit 15.

The detection module 152 receives the digital voltage signals from the analog-to-digital converter 23, detects a voltage of the digital voltage signals to obtain a detected voltage, and compares the detected voltage with a predetermined value. The predetermined value is a threshold amount of remaining voltage of the power supply 13. When the detected voltage is less than the predetermined value, this means the remaining voltage of the power supply 13 is low. Accordingly, usage of the mobile phone 10 should be limited. For example, such usage is restricted to performing only certain functions, such as searching desired contact information in the address list if necessary. Thus, the detection module 152 conveys the result of the comparison of the detected voltage with the predetermined value to the controlling module 151. At this time, the controlling module 151 detects a current mode of the mobile phone 10.

If the detected voltage is equal to or less than the predetermined value, and the mobile phone 10 is in the power conserving mode, the controlling module 151 does not signal the mobile phone 10 to change the current mode. However, if the mobile phone 10 is in the normal mode, the controlling module 151 signals the mobile phone 10 to change from the normal mode to the power conserving mode, and then signals the power management unit 14 to stop distributing voltage to the backlight unit 17 and/or the communication unit 18.

If the detected voltage is greater than the predetermined value, and the mobile phone 10 is in the normal mode, the controlling module 151 does not signal the mobile phone 10 to change the current mode. However, if the mobile phone 10 is in the power conserving mode, the controlling module 151 signals the power management unit 14 to resume distributing voltage to the backlight unit 17 and/or the communication unit 18, and then signals the mobile phone 10 to change from the power conserving mode to the normal mode.

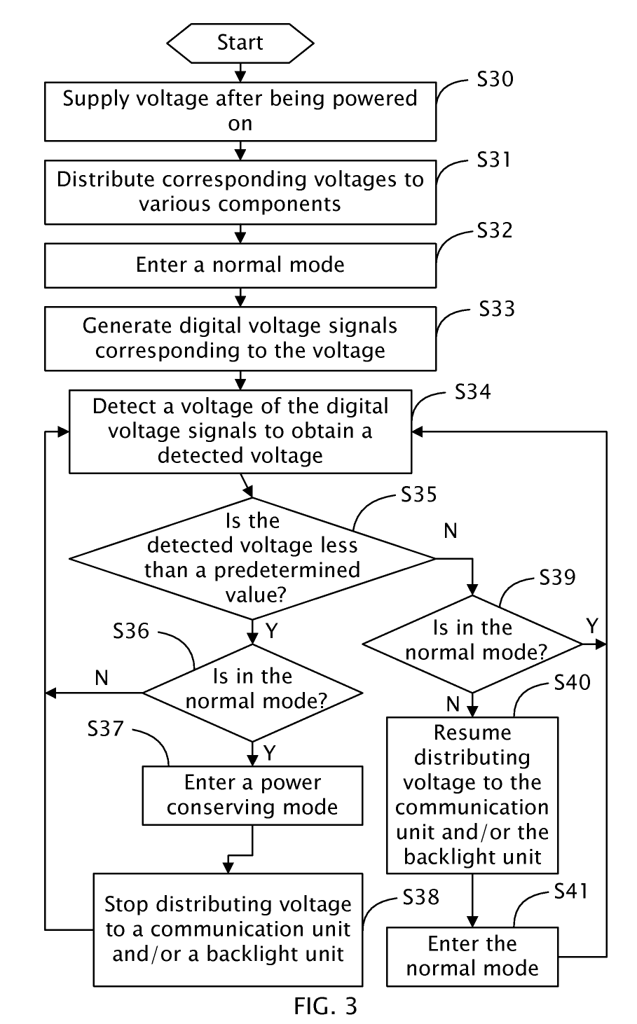

FIG. 3 is a flowchart of an exemplary method for conserving power of the mobile phone 10. In step S30, after the mobile phone 10 is powered on, the power supply 13 supplies voltage to the power management unit 14 and the analog-to-digital converter 23.

In step S31, the power management unit 14 receives the voltage from the power supply 13, and distributes corresponding voltages to various units of the mobile phone 10.

In step S32, the controlling module 151 signals the mobile phone 10 to enter the normal mode after being powered by the voltage of the central processing unit 15.

In step S33, the analog-to-digital converter 23 generates digital voltage signals corresponding to the voltage supplied by the power supply 13.

In step S34, the detection module 152 receives the digital voltage signals, and detects a voltage of the digital voltage signals to obtain a detected voltage.

In step S35, the detection module 152 determines whether the detected voltage is equal to or less than the predetermined value.

If in step S35 the detected voltage is equal to or less than the predetermined value, then in step S36, the controlling module 151 detects a current mode of the mobile phone 10.

If the mobile phone 10 is in the power conserving mode, the controlling module 151 does not signal the mobile phone 10 to change the current mode, and the procedure goes back to step S34. If the mobile phone 10 is in the normal mode, in step S37, the controlling module 151 signals mobile phone 10 to change from the normal mode to the power conserving mode, whereupon the procedure goes to step S38.

In step S38, the controlling module 151 signals the power management unit 14 to stop distributing voltage to the backlight unit 17 and/or the communication unit 18, whereupon the procedure goes back to step S34.

If in step S35 the detected voltage is greater than the predetermined value, then in step S39, the controlling module 151 detects a current mode of the mobile phone 10.

If the mobile phone 10 is in the normal mode, the controlling module 151 does not signal the mobile phone 10 to change the current mode, and the procedure goes back to step S34. If the mobile phone 10 is in the power conserving mode, in step S40, the controlling module 151 signals the power management unit 14 to resume distributing voltage to the backlight unit 17 and/or the communication unit 18, whereupon the procedure goes to step S41.

In step S41, the controlling module 151 signals the mobile phone 10 to change from the power conserving mode to the normal mode, whereupon the procedure goes back to step S34. Steps S34 to S41 are then performed iteratively if and as necessary until the mobile phone 10 is powered off.

It is understood that the invention may be embodied in various other forms without departing from the spirit thereof. Thus, the present examples and embodiments are to be considered in all respects as illustrative and not restrictive, and the invention is not to be limited to the details given above.

What is claimed is:

1. A portable communication device able to conserve power, the portable communication device comprising:
a power supply configured for supplying voltage;
a power management unit configured for receiving the voltage from the power supply, and distributing one or more corresponding voltages to other units of the portable communication device;
an analog-to-digital converter configured for receiving the voltage from the power supply, and generating digital voltage signals corresponding to the voltage; and
a central processing unit comprising:
a controlling module configured for signaling the portable communication device to enter a normal mode after being powered by a voltage of the central processing unit; and
a detection module configured for receiving the digital voltage signals from the analog-to-digital converter, detecting a voltage of the digital voltage signals to obtain a detected voltage, and comparing the detected voltage with a predetermined value;
wherein if the detected voltage is equal to or less than the predetermined value and a current mode of the portable communication device is the normal mode, the controlling module signals the portable communication device to change from the normal mode to a power conserving mode, and when the portable communication device changes from the normal mode to the power conserving mode, the controlling module signals the power management unit to stop distributing voltage to at least one of units of the portable communication device selected from the group consisting of a communication unit and a backlight unit.

2. The portable communication device according to claim 1, wherein if the detected voltage is greater than the predetermined value and the current mode of the portable communication device is the normal mode, the controlling module does not signal the portable communication device to change the current mode.

3. The portable communication device according to claim 1, wherein if the detected voltage is greater than the predetermined value and the current mode of the portable communication device is the power conserving mode, the controlling module signals the power management unit to resume distributing voltage to said at least one of the units of the portable communication device selected from the group consisting of the communication unit and the backlight unit, and signals the portable communication device to change from the power conserving mode to the normal mode.

4. The portable communication device according to claim 1, wherein if the detected voltage is equal to or less than the predetermined value and the current mode of the portable communication device is the power conserving mode, the controlling module does not signal the portable communication device to change the current mode.

5. A method for conserving power of a portable communication device, comprising:
supplying voltage by a power supply of the portable communication device;
distributing one or more corresponding voltages to other units of the portable communication device;
the portable communication device entering a normal mode after being powered by one of said one or more corresponding voltages;
generating digital voltage signals corresponding to the voltage supplied by the power supply;
detecting a voltage of the digital voltage signals to obtain a detected voltage;
comparing the detected voltage with a predetermined value; and
changing a current mode of the portable communication device from the normal mode to a power conserving mode, if the detected voltage is equal to or less than the predetermined value and the current mode is the normal mode; and
stopping distribution of at least one of said one or more corresponding voltages to at least one of units of the portable communication device selected from the group consisting of a communication unit and a backlight unit, when the current mode is changed from the normal mode to the power conserving mode.

6. The method according to claim 5, further comprising not signal the portable communication device to change the current mode, if the detected voltage is greater than the predetermined value and the current mode is the normal mode.

7. The method according to claim 5, further comprising if the detected voltage is greater than the predetermined value and the current mode is the power conserving mode, resuming distribution of at least one of said one or more corresponding voltages to said at least one of the units of the portable communication device selected from the group consisting of the communication unit and the backlight unit, and signaling the portable communication device to change from the power conserving mode to the normal mode.

8. The method according to claim 5, further comprising maintaining the current mode of the portable communication device, if the detected voltage is equal to or less than the predetermined value and the current mode is the power conserving mode.
